(19) United States
(12) Patent Application Publication
(10) Pub. No.: US 2022/0177208 A1
(43) Pub. Date: Jun. 9, 2022

(54) MULTI-LAYERED PACKAGING MATERIALS CONTAINING POST CONSUMER RESIN AND PROCESSES FOR MAKING SAME

(71) Applicant: ExxonMobil Research and Engineering Company, Annandale, NJ (US)

(72) Inventors: Donna S. Davis, Montgomery, TX (US); Jeffery C. Fitch, Spring, TX (US); Robert M. Canright, Huffman, TX (US); Lori J. Schellenger, Montgomery, TX (US); Mohan Kalyanaraman, Media, PA (US)

(21) Appl. No.: 17/455,295

(22) Filed: Nov. 17, 2021

Related U.S. Application Data
(60) Provisional application No. 63/121,329, filed on Dec. 4, 2020.

(51) Int. Cl. B65D 65/40; B32B 27/32; B32B 27/36; B32B 27/08

(52) U.S. Cl. CPC B65D 65/40; B32B 27/32; B32B 27/20; B32B 27/08; B65D 2565/384; B32B 27/36

(57) ABSTRACT

Multi-layered packaging materials. In an embodiment, a packaging material includes: an outer layer comprising a colorant and from about 70 wt % to about 99 wt % of a first post consumer resin (PCR); and an inner layer comprising a polymer and being about 3 wt % to about 99 wt % of the total packaging material. The packaging material can also include a middle comprising another colorant and from about 70 wt % to about 100 wt % of another PCR. In another embodiment, a packaging material includes: an outer layer comprising a first colorant and from about 70 wt % to about 99 wt % of a first virgin polymer; a middle layer that is about 40 wt % to about 95 wt % of the total packaging material, the middle layer comprising a PCR; and an inner layer comprising a second virgin polymer. The foregoing packaging materials can be made by co-extruding the different layers therein.

### CROSS-REFERENCE TO RELATED APPLICATIONS

This application claims the benefit of U.S. Provisional Application No. 63/121,329 filed on Dec. 4, 2020, the entire contents of which are incorporated herein by reference.

### FIELD

Embodiments of the present invention generally relate to polymeric packaging materials. More particularly, such embodiments relate to multi-layered packaging materials containing postconsumer resin and processes for making same.

### BACKGROUND

Post consumer resin (PCR) is increasingly being utilized by food and beverage companies for incorporation into product packaging due to consumer demand, regulatory requirements, and environmental benefits. There are many advantages to using PCR in product packaging rather than using virgin polymers, i.e., polymers in their original state that have never been used by consumers before. For example, recycling PCR reduces the amount of plastic sent to landfills and the amount of petroleum needed to make new, virgin polymers, thus extending the life of petroleum reserves. Also, PCR typically requires fewer resources (e.g., water, energy, green house gas) to produce than virgin polymers.

Post consumer resin may be mechanically recycled (including cleaning and melt filtration before re-extrusion) or chemically (advanced) recycled, which may include solvent extraction or thermal or catalytic or chemical recovery to smaller chemical and polymerization feedstocks. Chemically recycled post consumer resins are essentially “neat polymers” and thus are fully interchangeable with virgin materials. Mechanically recycled post consumer resins may exhibit contamination or degradation and thus may require special consideration as addressed herein.

Conventional packaging materials with PCR usually include a single layer composed of a mixture of virgin polymer, PCR, and colorant. Unfortunately, the quality of packaging materials typically declines when high levels of PCR are present in the materials. In particular, the packaging materials have poorer properties such as Environmental Stress Crack Resistance (ESCR), resistance to top load (stiffness), and Drop Impact Strength. Also, the color of packaging materials containing significant amounts of PCR rather than virgin polymers can be harder to control.

Two types of mechanically recycled PCR are natural (non-colored) PCR and colored PCR. Natural PCR is commonly referred to as “natural-color PCR”, whereas colored PCR containing a mixture of colors is commonly referred to as “mixed-color PCR”. Natural-color PCR is typically recovered from materials which have not been colored with pigments nor tints. Examples of these materials include packages for milk and water which are not chemically aggressive. Mixed-color PCR is typically recovered from materials featuring particular brand colors recognized by consumers and thus is often associated with more chemically aggressive products such as detergents and lubricants. As such, packaging materials containing mixed-color PCR often require ESCR modification. However, the variety of colors present in mixed-color PCR along with degradation byproducts undesirably cause these polymers to appear green, gray, or black in color, negatively impacting PCR utilization, which is unfortunate since mixed-color PCR is more widely available.

Therefore, a need exits to maximize the use of PCR in packaging materials without compromising the mechanical properties and appearance of such packaging. It is also desirable to increase the amount of mixed-color PCR used in packaging materials, including when packaging more chemically aggressive products such as detergents and lubricants.

### SUMMARY

Multi-layered packaging materials containing post consumer resin and processes for making same are provided. In one or more embodiments, a packaging material can include: an outer layer comprising a first colorant and from about 70 wt % to about 99 wt % of a first post consumer resin (PCR); and an inner layer that comprises a polymer and that is about 3 wt % to about 99 wt % of the total packaging material. The polymer of the inner layer can include a virgin polymer, a mixed-color PCR, and/or a natural-color PCR. The packaging material can also include a middle layer comprising from about 70 wt % to about 100 wt % of another PCR and another colorant, which can be the same or different from the other PCR's and colorants in the packaging material. The packaging material can be made by co-extruding the different layers therein.

In additional embodiments, a packaging material can include: an outer layer comprising a colorant and from about 70 wt % to about 99 wt % of a first virgin polymer; a middle layer that comprises a PCR and that is about 40 wt % to about 95 wt % of the total packaging material; and an inner layer comprising a second virgin polymer. The packaging material can be made by co-extruding the different layers therein.

In other embodiments, the packaging material can include: an outer layer comprising a colorant; a middle layer that comprises a PCR and that is about 40 wt % to about 95 wt % of the total packaging material; and an inner layer comprising a virgin polymer. The packaging material can be made by co-extruding the different layers therein.

### BRIEF DESCRIPTION OF THE DRAWINGS

So that the manner in which the above recited features of the present invention can be understood in detail, a more particular description of the invention, briefly summarized above, can be had by reference to embodiments, some of which are illustrated in the appended drawings. It is to be noted, however, that the appended drawings illustrate only typical embodiments of this invention and are therefore not to be considered limiting of its scope, for the invention can admit to other equally effective embodiments.

The FIGURE depicts a cross-sectional view of optional layouts of a multi-layered packaging material, according to one or more embodiments described herein.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

In the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass %.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

The term “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

The term “alpha-olefin” or “α-olefin” refers to an olefin having a terminal carbon-to-carbon double bond in the structure thereof. R¹R²C═CH₂, where R¹ and R² can be independently hydrogen or any hydrocarbyl group; such as R¹ is hydrogen and R² is an alkyl group. A “linear α-olefin” is an α-olefin wherein R¹ is hydrogen and R² is hydrogen or a linear alkyl group. For purposes of this specification and the claims appended thereto, when a polymer or copolymer is referred to as including an α-olefin, e.g., poly-α-olefin, the α-olefin present in such polymer or copolymer is the polymerized form of the α-olefin.

The term “polymer” refers to any two or more of the same or different repeating units/mer units or units. The term “homopolymer” refers to a polymer having units that are the same. The term “copolymer” refers to a polymer having two or more units that are different from each other, and includes terpolymers and the like. The term “terpolymer” refers to a polymer having three units that are different from each other. The term “different” as it refers to units indicates that the units differ from each other by at least one atom or are different isomerically. Likewise, the definition of polymer, as used herein, includes homopolymers, copolymers, and the like. By way of example, when a copolymer is said to have a “propylene” content of 10 wt % to 30 wt %, it is understood that the repeating unit/mer unit or simply unit in the copolymer is derived from propylene in the polymerization reaction and the derived units are present at 10 wt % to 30 wt %, based on a weight of the copolymer.

The term “packaging material” refers to a material that is capable of enclosing, storing, and/or protecting a product. The term “post consumer resin” (PCR) refers to polymeric material generated by households or by comnimercial, industrial, or institutional facilities in their role as end-users of the material, which can no longer be used for its intended purpose, and which is now being reused rather than being disposed of as solid waste. The term “virgin polymer” refers to a polymer in its original (neat) form and can include polymers made from chemically recycled PCR, which exhibits virgin polymer qualities and performance. The term “colorant” refers to a dispersion of pigment in a polymeric base. The term “modifier” refers to a chemical composition added to a material to alter its properties. Also, the term “waste material” refers to excess material formed during production of a packaging material that does not form part of the final product.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

A detailed description will now be provided. Each of the appended claims defines a separate invention, which for infringement purposes is recognized as including equivalents to the various elements or limitations specified in the claims. Depending on the context, all references to the “invention” can in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

### Multi-Layered Packaging Material

A multi-layered packaging material is disclosed that can include an outer layer containing at least one colorant and at least one polymer and an inner layer that is 3 to 99 wt % of the overall packaging material. As used herein, the term “outer layer” refers to the skin of the packaging material that is typically seen by consumers, and the term “inner layer” refers to the layer of the packaging material that contacts the product being stored or protected by the package. The amount of polymer present in the outer layer preferably ranges from 70 to 99 wt %, more preferably from 80 to 95 wt %. The amount of colorant present in the outer layer preferably ranges from 1 to 30 wt %, more preferably from 3 to 25 wt %, most preferably from 5 to 20 wt %. It is recognized that the amount of colorant could be increased up to almost 100 wt % if desired. For example, the amount of colorant utilized can be maximized to make the packaging material easily identifiable by consumers as a certain brand.

In addition to the colorant, the outer layer most preferably contains natural-color PCR (nc-PCR) to avoid the green-gray color associated with mixed-color PCR (mc-PCR). However, the outer layer can also contain virgin (neat) polymer or even mc-PCR. Alternatively, the outer layer can primarily contain colorant as opposed to virgin polymer and colorant. In this case, the colorant can be or can include pigment dispersed in linear low-density polyethylene (LLDPE), high-density polyethylene (HDPE), and/or other suitable polymers known in the art.

The inner layer can include from 70 to 100 wt % of at least one virgin (neat) polymer. For example, the inner layer can include 100 wt % of a virgin polymer or from 80 to 90 wt % of a virgin polymer. Alternatively, the inner layer can include from 70 to 100 wt %, preferably from 90 to 100 wt %, of at least one mc-PCR. Another alternative is that the inner layer can include from 70 to 95 wt %, preferably 80 to 90 wt %, of at least one nc-PCR. The inner layer can also include a balance of colorant relative to the other components of the inner layer. It is recognized that the inner layer could also primarily contain colorant as opposed to virgin polymer and colorant; however, this use of primarily colorant in the inner layer may be less economical.

The multi-layered packaging material can optionally include at least one middle layer between the inner and outer layers. Preferably, the middle layer directly contacts the outer layer of the packaging materials. Since the outer layer of the packing material can contain a relatively high amount of colorant, the middle layer and/or the inner layer can include large amounts of PCR, particularly mc-PCR, without compromising the appearance and the properties of the packaging material. The use of multiple layers in the packaging material surprisingly allows for the PCR content of the packaging material to be increased up to, for example, 98.5 wt % based on the total weight of the packaging material. Also, it is desirable to maximize the thickness of the middle layer for economic and performance reasons.

In some embodiments in which the packaging material includes a middle layer, the middle layer can include from 70 to 100%, preferably from 90 to 100 wt %, more preferably from 95 to 100 wt %, of at least one PCR, preferably a mc-PCR. The inner layer can also include a balance of colorant relative to the other components of the inner layer. The inner layer and the outer layer can each make up 3 to 40 wt %, preferably from 3 to 20 wt %, and more preferably 5 to 10 wt %, of the total packaging material such that the middle layer is significantly thicker than the inner and outer layers. The middle layer can make up 40 to 95 wt %, preferably 60 to 95 wt %, and more preferably 80 to 95 wt %, of the total packaging material.

In other embodiments, the middle layer can include waste material (also known as “regrind”) left over from the production of previously-formed packaging material. For example, such waste material could be material that is pinched off the top of a bottle after the bottle is formed by blow molding. The waste material thus can include virgin polymer, PCR, and/or colorant that is reground for recycling in subsequently produced packaging materials. In addition to the waste material, the middle layer can also include from 40 to 60%, preferably from 45 to 55%, of at least one PCR, preferably a mc-PCR.

It is to be understood that the type of virgin polymer and/or PCR present in each layer can be the same or different.

The FIGURE illustrates different layouts of the multi-layered packaging material. A first layout 10 of the packaging material can include an outer layer and an inner layer that is preferably larger than the outer layer. A second layout 20 of the packaging material can include at least one middle layer between the outer and the inner layers, with the middle layer preferably being larger than the outer and the inner layers.

The properties of the packaging material, such as ESCR, resistance to top load, and Drop Impact Resistance, can be optimized by adjusting the types of polymers present in the different layers. For example, a packaging material having an inner layer of a virgin polymer, e.g., HDPE, a middle layer of a mc-PCR, and an outer layer of a mc-PCR mixed with a colorant can have higher ESCR and Drop Impact Resistance than the same packaging material minus the virgin polymer layer. Also, a packing material having an inner layer of a mc-PCR, a middle layer of a mc-PCR, and an outer layer of a nc-PCR mixed with a colorant can have higher ESCR and Drop Impact Resistance than another packaging material that is the same except that the inner layer has nc-PCR mixed with a colorant. While both of these packaging materials can have good color and gloss values, which quantify appearance, the one with nc-PCR in the inner layer surprisingly has better color values.

Also, the appearance (e.g., the color and gloss values) of the packaging material can be altered by adding colorant to the outer, middle, and/or inner layers. Since the colorant is the most expensive material in the packaging material, it is desirable to minimize the concentration of the colorant as limited by its appearance. Including colorant in the outer layer is particularly useful while at the same time minimizing the concentration of the colorant and the thickness of the outer layer based on the desired color intensity. Examples of the type of colorants that can be used include pearlescent silver, blue, red, yellow, green, gold, white, black, etc. The particular colorants that are used depend on the design of the packaging material, which is typically influenced by the brand of the product being packaged.

Various additives can be added to the different layers of the packaging material to improve its performance. For example, polymer processing aids can be included in the outer layer to reduce processing and appearance problems caused by the colorant sticking to hardware and clumping together during processing. Also, non-stick agents such as fluorinated agents can added to the inner layer to promote better evacuation of the product with minimal residue. Optionally, the inside of the packaging material can be subjected to fluorination before the product is added. In addition, modifiers can be included in the inner and/or outer layers to increase ESCR and/or Drop Impact Resistance. The modifiers can be or can include polyolefin-based elastomers or plastomers and high-performance polyolefins. VISTAMAXX® propylene-based copolymers and EXACT® and ENGAGE® ethylene-based copolymers commercially available from ExxonMobil Chemical Co. are examples of suitable elastomers. EXCEED® and ENABLE® ethylene-based copolymers, which are commercially available from ExxonMobil and Dow Chemical Co., respectively, are examples of suitable high-performance polyolefins. The amount of modifier in each layer can range from 0 to 15 wt %.

The packaging material can be made by, for example, blow molding, injection molding, and film extrusion, each of which is commonly known in the art. Film extrusion typically involves coextruding the layers of the packaging material into a film. Blow molding typically involves coextruding the layers of the packaging material to provide molten plastic which is then blown within a mold to form the packaging material, e.g., bottle, with the desired shape and construction. Injection molding typically involves coextruding the layers of the packaging material to provide molten plastic and injecting the molten plastic into a mold of the desired shape and construction. Blow molding can be used to form, for example, plastic bottles and pouches, whereas injection molding and film extrusion can be used to form, for example, plastic pails and pouches.

The packaging material can be used to protect or store any type of product. Some examples of products for which the packaging material can be used include water, milk, soda, other drinks, detergent, vitamins, medicine, shampoo, condiments, lubricant, cooking oil, etc.

### Post Consumer Resin

The PCR can be any suitable PCR commonly used in the art for packaging materials, including mechanically recycled PCR and chemically recycled PCR. Examples of suitable PCR include high-density polyethylene, polypropylene, polyethylene terephthalate, or combinations thereof.

The PCR can include natural-color PCR (nc-PCR) and/or mixed-color PCR (mc-PCR). A particularly suitable nc-polymer is commercially available from KW Plastics under the tradename KW-101. A particularly suitable me-PCR is commercially available from KW Plastics under the tradename KW-102.

### Virgin Polymer

The virgin polymer can be any suitable polymer commonly used in the art for packaging materials and can be manufactured with monomer recovered from PCR in addition to traditional hydrocarbon sources. Examples of virgin polymers suitable for use in plastic bottles include high-density polyethylene (HDPE), low-density polyethylene (LDPE), polyethylene terephthalate (PET), polystyrene, polypropylene, polycarbonate, and polyvinyl chloride. These virgin polymers can be multimodal or unimodal and can have a wide range of densities and molecular weights, depending on the type of polymer being used and thus are not limited to the HDPE compositions described below. Examples of suitable commercially available HDPE virgin polymers include: PAXON SP5504 and HYA-600 sold by ExxonMobil.

Particularly suitable polyethylene (HDPE) compositions and processes for making same are described below and in U.S. Provisional Application No. 63/070,171, which is incorporated by reference herein. The polyethylene compositions can include polyethylene homopolymers, and/or copolymers of ethylene and one, two, three, four or more C₃ to C₄₀ olefin comonomers, for example, C₃ to C₂₀ α-olefin comonomers. For example, the polyethylene compositions can include copolymers of a C₂ to C₄₀ olefin and one, two or three or more different C₂ to C₄₀ olefins. In particular embodiments, the polyethylene compositions comprise a majority of units derived from polyethylene, and units derived from one or more C₃ to C₄₀ comonomers, preferably C₃ to C₂₀ α-olefin comonomers (e.g., propylene, 1-butene, 1-hexene, 1-octene, 1-decene, 1-dodecene, preferably propylene, 1-butene, 1-hexene, 1-octene, or a mixture thereof; most preferably 1-butene and/or 1-hexene).

The polyethylene compositions can include the ethylene-derived units in an amount of at least 80 wt %, or 85 wt %, preferably at least 90, 95, 96, 97, 98, or 99 wt % (for instance, in a range from a low of 80, 85, 90, 95, 98, 99.0, 99.1, 99.2, 99.3, or 99.4 wt %, to a high of 96, 97, 98.1, 98, 98.2, 98.3, 98.4, 98.5, 98.6, 98.7, 98.8, 98.9, 99.0, 99.1, 99.2, 99.3, 99.4, 99.5, 99.6, 99.7, 99.8, or 99.9 wt %, with ranges from any foregoing low end to any foregoing high end contemplated, provided the high is greater than the low). For instance, the polyethylene composition can comprise 95, 98, 98.5, 99, 99.1, 99.2, or 99.3 to 99.9 wt % ethylene-derived units. Comonomer units (e.g., C₂ to C₂₀ α-olefin-derived units, such as units derived from butene, hexene, and/or octene) can be present in the polyethylene composition within the range from a low of 0.1, 0.2, 0.3, 0.4, 0.5, 0.6, 0.7, 0.8, 0.9, 1.0, 2.0, 3.0, 4.0, or 5.0 wt %, to a high of 0.7, 0.8, 0.9, 1, 1.1, 1.2, 1.3, 1.4, 1.5, 1.6, 1.7, 1.8, 1.9, 2, 3, 4, 5, 10, 15, or 20 wt %, with ranges from any foregoing low ends to any foregoing high ends contemplated, provided the high is greater than the low end). For instance, the polyethylene composition can comprise 0.1 wt % to 0.7, 0.8 0.9, 1.0, 1.5, or 5.0 wt % comonomer units.

Several suitable comonomers have already been noted, although in various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as butene, hexene, octene as already noted), and α-olefins having one or more C₁-C₃ alkyl branches, or an aryl group. Specific examples include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

In various embodiments, the polyethylene compositions also comprise trace, but detectable, amounts of titanium and/or chromium. For instance, polyethylene compositions can include Cr in an amount from a low of 2.0, 2.1, 2.2, 2.3, 2.4, or 2.5 ppm to a high of 3.5, 3.6, 3.7, 3.8, 3.9, 4.0, 4.5, or 5.0 ppm (on the basis of mass of the polyethylene composition), with ranges from any foregoing low to any foregoing high contemplated herein. Likewise, polyethylene compositions can include Ti in an amount from a low of 5, 6, 7, or 8 ppm to a high of 13, 14, 15, 16, 17, 18, 19, or 20 ppm, also with ranges from any foregoing low to any foregoing high contemplated herein.

In one or more embodiments, the polyethylene compositions have a density of 0.930 to 0.975 g/cm³, such as 0.938 to 0.965 g/cm³. For example, ethylene polymers can have a density from a low end of 0.935, 0.938, 0.940, 0.945, 0.950, 0.952, 0.953, 0.954, or 0.955 g/cm³ to a high end of 0.957, 0.958, 0.959, 0.960, 0.965, 0.970 or 0.975 g/cm³, with ranges of various embodiments including any combination of any upper or lower value disclosed herein. Density herein is measured according to ASTM D1505-19 (gradient density) using a density-gradient column on a plaque. The plaque is molded according to ASTM D4703-10a, procedure C, and the plaque is conditioned for at least 40 hours at 23° C. to approach equilibrium crystallinity in accordance with ASTM D618-08.

In various embodiments, the polyethylene compositions have one or more, two or more, or, preferably, all of the following molecular weight properties:

weight-average molecular weight (Mw) within the range generally from 90,000 to 300,000, such as from a low end of any one of 100,000 g/mol; 110,000 g/mol; 120,000 g/mol; 130,000 g/mol; 140,000 g/mol; 150,000 g/mol; and 160,000 g/mol, to a high end of any one of 160,000 g/mol; 170,000 g/mol; 180,000 g/mol; 190,000 g/mol; 200,000 g/mol; 210,000 g/mol; 225,000 g/mol; 250,000; and 300,000 g/mol. Ranges from any one of the foregoing low ends to any one of the high ends are contemplated in various embodiments, provided the high end is greater than the low end. For example, Mw can be within the range from 130,000 to 300,000 g/mol in particular embodiments, such as 150,000 g/mol to 180,000; 200,000; 225,000; or 250,000 g/mol.

Number-average molecular weight (Mn) generally within the range from 5,000 to 30,000, such as from a low end of any one of 5,000 g/mol; 6,000 g/mol; 7,000 g/mol; 8,000 g/mol; 9,000 g/mol, to a high end of any one of 10,000 g/mol; 11,000 g/mol; 12,000 g/mol; 13,000 g/mol; 14,000 g/mol; 15,000 g/mol; 17,500 g/mol; 20,000 g/mol; 22,500 g/mol; 25,000 g/mol; 27,500 g/mol; and 30,000 g/mol. Ranges from any one of the foregoing low ends to any one of the high ends are contemplated in various embodiments (for instance, Mn can be within the range from 5,000 g/mol to 15,000 g/mol, such as 5,000 or 6,000 g/mol to 11,000 or 12,000 g/mol). More generally, in some embodiments, Mn can be 12,000 g/mol or less, such as 11,000 g/mol or less.

Z-average molecular weight (Mz) generally within the range from 700,000 to 3.0M g/mol, such as from a low end of any one of 700,000 g/mol; 800,000 g/mol; 900,000 g/mol; 1.0M g/mol; 1.1M g/mol; 1.2M g/mol; 1.3M g/mol; 1.40M g/mol; 1.45M g/mol; 1.50M g/mol; 1.55M g/mol; and 1.60M g/mol, to a high end of any one of 1.65M g/mol; 1.70M g/mol; 1.75M g/mol; 1.80M g/mol; 1.85M g/mol; 1.90M g/mol; 1.95M g/mol; 2.0M g/mol; 2.5M g/mol; 2.75M g/mol; and 3.0M g/mol. Ranges from any one of the foregoing low ends to any one of the high ends are contemplated in various embodiments (for instance, Mz can be within the range from 1.0M to 3.0 M g/mol, such as 1.5M to 3.0M g/mol; or 1.50M to 2.0M g/mol, such as 1.60M to 1.65M g/mol). In particular embodiments, Mz can be at least 1.0M g/mol, such as at least 1.50M g/mol, or at least 1.60M g/mol, with no upper limit necessarily contemplated.

Z-plus-one average molecular weight (M_{z+1}) within the range from a low end of any one of 2.75M, 3.0M, 3.25M, 3.5M, or 3.75M g/mol, to a high end of any one of 4.0M, 4.1M, 4.2M, or 4.5M g/mol, with ranges from any one of the foregoing low ends to any one of the foregoing high ends contemplated (e.g., 3.5M g/mol to 4.2M g/mol, or 2.75M g/mol to 4.5M g/mol, such as 3.75M to 4.5M g/mol). In certain embodiments, M_{z+1} can be at least 3.5M, such as at least 3.75M, g/mol, with no upper limit necessarily contemplated.

Furthermore, polyethylene compositions in accordance with various embodiments can have Mw/Mn value (sometimes also referred to as polydispersity index, PDI) within the range from 10, 12, 15, or 16 to 17, 18, 19, 20, 22, 25, 26, or 27 (with ranges from any low end to any high end contemplated, such as Mw/Mn from 12 to 25, or 15 to 20). Similarly, Mz/Mw ratio of the polyethylene compositions of various embodiments are within the range from 5, 6, 7, 8, or 9 to 10, 11, 12, 13, 14, 15, 17, or 20 (with ranges from any low end to any high end contemplated, such as Mz/Mw from 5 to 15, such as from 7 to 12). Mz/Mn ratio (indicating the broadness of the overall distribution of molecular weights among chains within the polymer by considering the two characteristic values of very high molecular-weight chains (Mz) and very low molecular-weight chains (Mn)) can be within a range from 100, 110, 115, 120, 125, 130, 135 or 140; to 150, 160, 170, 180, 190, 200, 250, 300, 350, or 400 (with ranges from any low end to any high end contemplated, such as Mz/Mn from 110 to 250, or from 130 to 200, such as 140 to 160). In certain embodiments, Mz/Mw ratio can be at least 8, 9, or 10, without a particular upper bound necessarily required. Similarly, in certain embodiments, Mz/Mn ratio can be at least 130, such as at least 140, at least 145, 150, or at least 160, without any upper bound necessarily required.

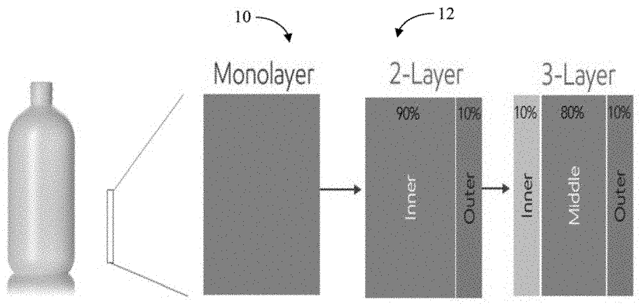

Furthermore, as noted, the polyethylene compositions of various embodiments described herein can exhibit unimodal molecular weight distribution, meaning that there is a single distinguishable peak in a molecular weight distribution curve of the composition (as determined using gel permeation chromatography (GPC) or other recognized analytical technique, noting that if there is any conflict between or among analytical techniques, a molecular weight distribution determined by GPC, as described below, shall control). Examples of “unimodal” molecular weight distribution can be seen in U.S. Pat. No. 8,691,715, FIG. 6 of such patent, which is incorporated herein by reference. This is in contrast with a “multimodal” molecular weight distribution, which means that there are at least two distinguishable peaks in a molecular weight distribution curve (again, as determined by GPC or any other recognized analytical technique, with GPC controlling in the event of any conflict). For example, if there are two distinguishable peaks in the molecular weight distribution curve such composition can be referred to as bimodal composition. For example, in the '715 patent, FIGS. 1-5 of that patent illustrate representative bimodal molecular weight distribution curves. In these Figures, there is a valley between the peaks, and the peaks can be separated or deconvoluted. Often, a bimodal molecular weight distribution is characterized as having an identifiable high molecular weight component (or distribution) and an identifiable low molecular weight component (or distribution).

In addition to exhibiting unimodal distribution of molecular weight, in particular embodiments, the polyethylene compositions can exhibit a long “high-molecular weight tail” in a plot of molecular weight fractions from GPC measurements (GPC measurement methods are detailed below). This long “high-molecular weight tail” in such unimodal embodiments can contribute to advantageous physical properties. Furthermore, Mz, M_{z+1}, and/or Mz/Mn values in accordance with the above-described ranges can be used to quantitatively indicate the presence of this long “high-molecular weight tail.”

Polyethylene compositions in accordance with various embodiments can have a g′ value (also referred to as g′vis, branching index, or long chain branching (LCB) index) equal to or greater than 0.92, 0.93, or 0.94. For instance, g′ can be within the range from 0.90, 0.91, 0.92, 0.93, or 0.94; to 0.95, 0.96, 0.97, 0.98, 0.99, or 1.0 (with ranges from any of the foregoing low ends to any of the foregoing high ends contemplated, such as 0.90 to 0.97, or 0.93 to 0.95).

The distribution and the moments of molecular weight (Mw, Mn, Mz, Mw/Mn, Mz/Mn, etc.), the monomer/comonomer content (C₂, C₄, C₆ and/or C₈, and/or others, etc.) and the long chain branching indices (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent Plgel 10 μm Mixed-B LS columns are used to provide polymer separation. Detailed analytical principles and methods for molecular weight determinations are described in paragraphs [0044]-[0051] of PCT Publication WO2019/246069A1, which are herein incorporated by reference (noting that the equation c=///referenced in Paragraph [0044] therein for concentration I at each point in the chromatogram, is c=βI, where β is mass constant and I is the baseline-sbutracted IR5 broadband signal intensity (I)). Unless specifically mentioned, all the molecular weight moments used or mentioned in the present disclosure are determined according to the conventional molecular weight (IR molecular weight) determination methods (e.g., as referenced in Paragraphs [0044]-[0045] of the just-noted publication), noting that for the equation in such Paragraph [0044], a=0.695 and K=0.000579 (1-0.75Wt) are used, where Wt is the weight fraction for hexane comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph [0045] of the just-noted PCT publication).

On the other hand, light scattering (LS) is used to determine branching index g′_{LCB} (also referred to as g′ᵥᵢₛ), in accordance with the methods described in Paragraphs [0048]-[0051] of PCT Publication WO2019/246069A1.

In one or more embodiments, the polyethylene compositions also exhibit at least two distinct crystalline fractions as determined by temperature rising elution fractionation (TREF) with an IR detector. Temperature Rising Elution Fractionation (TREF) analysis was performed using a Crystallization Elution Fractionation (CEF) instrument from Polymer Char, S. A., Valencia, Spain. The principles of CEF analysis and a general description of the particular apparatus used are given in the article Monrabal, B. et al., Crystallization Elution Fractionation: A New Separation Process for Polyolefin Resins, Macromol. Symp. 2007, 257, 71. In particular, a process conforming to the “TREF separation process” shown in FIG. 1a of the Monrabal article, in which F_{c}=0, can be used. The polyethylene compositions can exhibit 2 or more well-defined peaks in the TREF curve, where there is a valley between the peaks and the peaks can be separated (or deconvoluted).

In various embodiments, the polyethylene compositions have melt index, (MI, also referred to as I₂ or I_{2.16} in recognition of the 2.16 kg loading used in the test) within the range from 0.1 g/10 min to 5 g/10 min, such as from a low of any one of 0.1, 0.2, and 0.3 g/10 min, to a high of 0.5, 0.55, 0.60, 0.65, 0.70, 0.75, 1.0, 1.2, 1.5, 1.7, 2.0, 3.0, 4.0, 5.0, or 10.0 g/10 min, with ranges from any of the foregoing low ends to any of the foregoing high ends contemplated herein) (e.g., 0.1 to 1.0 or 2.0 g/10 min, such as 0.3 to 0.5 g/10 min). Moreover, polyethylene compositions of various embodiments can have a high load melt index (HLMI) (also referred to as I₂₁ or I_{21.6} in recognition of the 21.6 kg loading used in the test) within the range from a low of 20, 25, 28, 29, 30, or 31 g/10 min to a high of 35, 36, 37, 38, 39, 40, 45, 50, 60, 70, or 75 g/10 min; with ranges from any of the foregoing lows to any of the foregoing highs contemplated herein (e.g., 25 to 50 g/10 min, such as 30 to 40 g/10 min).

Polyethylene compositions according to various embodiments can have a melt index ratio (MIR, defined as I_{21.6}/I_{2.16}) within the range from a low of any one of 60, 65, 70, 75, 80, 81, 82, 83, 84, or 85 to a high of 88, 89, 90, 91, 92, 93, 94, 95, 100, or 110; with ranges from any of the foregoing lows to any of the foregoing highs contemplated herein (e.g., 60 to 100, such as 80 or 85 to 94 or 95).

Melt index (2.16 kg) and high-load melt index (HLMI, 21.6 kg) values can be determined according to ASTM D1238-13 procedure B, such as by using a Gottfert MI-2 series melt flow indexer. For MI, HLMI, and MIR values reported herein, testing conditions were set at 190° C. and 2.16 kg (MI) and 21.6 kg (HMLI) load. An amount of 5 g to 6 g of sample was loaded into the barrel of the instrument at 190° C. and manually compressed. Afterwards, the material was automatically compacted into the barrel by lowering all available weights onto the piston to remove all air bubbles. Data acquisition was started after a 6 min pre-melting time. Also, the sample was pressed through a die of 8 mm length and 2.095 mm diameter.

In various embodiments, the polyethylene composition exhibits shear-thinning rheology, meaning that for increasing shear rates, viscosity decreases. But, advantageously, even at low shear rates (less than 1 rad/s, preferably less than 0.5 rad/s, such as at 0.1 and 0.01 rad/s), the complex viscosity of the polyethylene compositions of such embodiments is relatively low. This rheology indicates good processability for the polyethylene compositions in accordance with such embodiments (insofar as the shear rates simulate the viscosity that the composition can exhibit when processed in extruders or similar equipment). Accordingly, a polyethylene composition according to various embodiments can exhibit one or more, preferably two or more, or even all, of the following rheological properties:

Degree of shear thinning, DST, within the range from a low of 0.965, 0.970, or 0.975 to a high of 0.980, 0.985, or 0.990, with ranges from any foregoing low to any foregoing high contemplated herein (e.g., 0.975 to 0.980). DST is a measure of shear-thinning rheological behavior (decreasing viscosity with increasing shear rate), defined as DST=[η*(0.01 rad/s)−η*(100 rad/s)]/η*(0.01 rad/s), where η*(0.01 rad/s) and η*(100 rad/s) are the complex viscosities at 0.01 and 100 rad/s, respectively.

Complex viscosity (at 628 rad/s, 190° C.) of 800, 700, 600, 500, or 450 Pa*s or less; such as within the range from a low of 200, 250, 300, 350, 400, 450, 500, or 550 Pa*s to a high of 300, 350, 400, 450, 500, 550, 600, 650, 700, 750, or 800 Pa*s, with ranges from any of the foregoing low ends to any of the foregoing high ends contemplated in various embodiments (provided the high end is greater than the low end) (e.g., 200 to 800 Pa*s, such as 300 to 500 Pa*s).

Complex viscosity (at 100 rad/s, 190° C.) of 3,000 Pa*s or less; such as 2,000; 1,900; 1,800; or 1,500 Pa*s or less; such as within the range from a low of 900; 1,000; 1,200; 1,300; or 1,350 to a high of 1,300; 1,400; 1,500; 1,750; 2,000; 2,250; 2,500; 2,750; or 3,000 Pa*s, with ranges from any low end to any high end contemplated herein (provided the high end is greater than the low end) (e.g., 900 to 3,000 Pa*s, such as 1,200 to 1,500 Pa*s).

Complex viscosity (at 0.01 rad/s, 190° C.) of 100,000 Pa*s or less; such as 80,000 Pa*s or less; or 75,000 Pa*s or less; or 65,000 Pa*s or less; or in some cases within the range from a low of 10,000; 15,000; 20,000; 30,000; 45,000; 50,000; or 55,000 Pa*s to a high of 60,000; 65,000; 70,000; 75,000; 80,000; 85,000; 90,000; 95,000; or 100,000 Pa*s, with ranges from any low end to any high end contemplated herein (provided the high end is greater than the low end) (e.g., 10,000 to 100,000 Pa*s, such as 50,000 to 75,000 Pa*s).

In particular embodiments, the polyethylene composition can be characterized by a combination of rheological and microstructural parameters according to the following relationship:

$$\frac{{M}_{z} HLMI}{{M}_{n} {η}_{low}}$$

where HLMI (or, equivalently, I_{21.6}), Mz, and Mn are as defined previously, and η_{low} is the complex viscosity at 628 rad/s. This relationship can be referred to herein as the “high-low ratio” because it provides a ratio of high-molecular weight polymer chain population to low-molecular weight polymer chain population in the polyethylene composition, also accounting for low viscosity rheological behavior. High-low ratio of various polyethylene compositions in accordance with the present disclosure can be within the range from a low of any one of 8, 9, 10, 10.5, 11, 11.5, or 12.0 to a high of any one of 14, 14.5, 15.0, 15.5, 16.0, 16.5, 17, 18, 19, or 20, with ranges from any of the foregoing lows to any of the foregoing highs contemplated herein (e.g., 8 to 20, 10 to 20, 10 to 16, 10 to 15.5, etc.).

Rheological data such as complex viscosity was determined using SAOS (small amplitude oscillatory shear) testing. SAOS experiments was performed at 190° C. using a 25 mm parallel plate configuration on an ARES-G2 (TA Instruments). Sample test disks (25 mm diameter, 2 mm thickness) were made with a Carver Laboratory press at 190° C. Samples were allowed to sit without pressure for approximately 3 minutes in order to melt and then held under pressure typically for 3 minutes to compression mold the sample. The disk sample was first equilibrated at 190° C. for about 10 minutes between the parallel plates in the rheometer to erase any prior thermal and crystallization history. An angular frequency sweep was next performed with a typical measurement gap of 1.5 mm from 628 rad/s to 0.01 rad/s angular frequency using 5 points/decade and a strain value within the linear viscoelastic region determined from strain sweep experiments (see C. W. Macosko, Rheology Principles, Measurements and Applications, Wiley-VCH, New York, 1994). All experiments were performed in a nitrogen atmosphere to minimize any degradation of the sample during the rheological testing.

In order to quantify the shear thinning rheological behavior, which is defined as the decrease of the viscosity at the increase of frequency or shear rate, we defined the degree of shear thinning (DST) parameter. The DST was measured by the following expression:

$$DST = [ {η}^{*} ( 0.001 rad \text{/} s ) - {η}^{*} ( 100 rad \text{/} s ) ] \text{/} {η}^{*} ( 0.001 rad \text{/} s )$$

where η*(0.01 rad/s) and η*(100 rad/s) are the complex viscosities at 0.01 and 100 rad/s, respectively. Complex viscosities values are shown merely to highlight that the inventive resins show lower viscosities values at 0.01 rad/s than the controls, but all resins have basically the same DST and comparable viscosities at 628 rad/s.

The virgin polymers described herein can be made using any suitable polymerization process known in the art. Any suspension, homogeneous, bulk, solution, slurry, or gas phase polymerization process known in the art can be used. Such processes can be run in a batch, semi-batch, or continuous mode. A homogeneous polymerization process is defined to be a process where at least about 90 wt % of the product is soluble in the reaction medium. A bulk process is defined to be a process where monomer concentration in all feeds to the reactor is 70 volume % or more. Alternately, no solvent or diluent is present or added in the reaction medium, (except for the small amounts used as the carrier for the catalyst system or other additives, or amounts typically found with the monomer; e.g., propane in propylene). A slurry polymerization process is defined to be a polymerization process in which a supported catalyst is used and monomers are polymerized on the supported catalyst particles within a liquid medium (comprising, e.g., inert diluent and unreacted polymerizable monomers), such that a two phase composition including polymer solids and the liquid circulate within the polymerization reactor. A gas phase polymerization process is defined to be a process in which a gaseous stream containing monomers is passed through a catalyst in a reactor under polymerization conditions. Commonly, the gaseous stream containing monomers is continuously cycled through a fluidized bed containing the catalyst.

### EXAMPLES

The foregoing discussion can be further described with reference to the following non-limiting examples.

Two polymeric 5-quart bottles having the same weight (190 g) (Examples 1 and 2) were blow molded that included an outer layer containing 85.0 wt % KW-102, which is a HDPE-based mc-PCR commercially available from KW Plastics, and 15.0 wt % colorant. The bottle of Ex. 1 also included an inner layer containing 100.0 wt % KW-102, and the bottle of Ex. 2 included a middle layer containing 100.0 wt % KW-102. Unlike the bottle of Ex. 1, the bottle of Ex. 2 included an additional layer (inner layer) containing 100.0 wt % PAXON SP5504, which is a virgin HDPE polymer commercially available from ExxonMobil.

Another polymeric bottle having the same size and weight as the bottles of Ex.1-2 (Comparative Example 1) was blow molded that included a single layer containing 72.0 wt % Marlex®-5502, which is a virgin HDPE polymer commercially available from Chevron Philips Chemical Company, LLC, 25.0 wt % KW-102, and 3.0 wt % colorant. The compositions and relative thicknesses of the different layers of the bottles of Ex.1-2 and C.Ex.1 are reported in Table 1 below. All blow molding mentioned in the Examples was performed using a B&W multi-layer shuttle blow molding machine commercially available from Uniloy Inc. All colorants used in the C.Ex.1 and Ex.1-2 contained pearlescent color pigment mixed with a LLDPE polymer.

The average resistance to top load, Drop Impact Resistance, and ESCR were measured for each bottle of Ex. 1-2 and C.Ex.1. The results of these measurements are shown in Table 1 below, and a description of these measurements are provided below. It was surprisingly found that the bottle of Ex.2, which primarily contained mc-PCR and an inner layer of HDPE virgin polymer, exhibited better Drop Impact Resistance and ESCR than the bottles of Ex.1 and C.Ex.1. Therefore the bottle of Ex.2 is less likely to experience failure induced by product contact compared to the bottles of Ex.1 and C.Ex.2. Also, the bottle of Ex. 1, which was made of two layers of mc-PCR with colorant in the outer layer, unexpectedly exhibited the highest resistance to top load of all the bottles.

TABLE 1
Compositions and Properties of Ex. 1-2 and C. Ex. 1

| | Layer | | | | | | |
|---|---|---|---|---|---|---|---|
| | Distribution, | | | | | | |
| | Inner/ | | | | Average | Drop | |
| | Middle/ | Inner | Middle | Outer | Top Load | Impact | |
| | Outer | Layer | Layer | Layer | Resistance | Resistance | ESCR |
| | (wt %) | (wt %) | (wt %) | (wt %) | (lbs) | (ft) | F50 |
| C. Ex. 1 | monolayer | | 72.0% | | 73.0 | 8 | 23 |
| | | | Marlex ® | | | | |
| | | | 5502/ | | | | |
| | | | 25.0% | | | | |
| | | | KW-102/ | | | | |
| | | | 3.0% | | | | |
| | | | colorant | | | | |
| Ex. 1 | 90/0/10 | 100.0% | | 85.0% | 113.0 | 4 | 32 |
| | | KW-102 | | KW-102/ | | | |
| | | | | 15% | | | |
| | | | | colorant | | | |
| Ex. 2 | 10/80/10 | 100.0% | 100.0% | 85.0% | 96.0 | 9 | 52 |
| | | PAXON | KW-102 | KW102/ | | | |
| | | SP5504 | | 15.0% | | | |
| | | | | colorant | | | |

Three additional 32-ounce polymeric bottles having the same weight (40 g) (Examples 3, 4, and 5), which were different in size and weight from the bottles of Ex. 1-2, were also blow molded. The bottles of Ex.3-5 all included outer, middle, and inner layers. The middle layer of all three bottles of Ex.3-5 contained 100.0 wt % KW-102 (mc-PCR). The outer layer of the bottles of Ex.3-4 contained 15.0 wt % colorant and 85.0 wt % KW-101, which is a HDPE-based nc-PCR commercially available from KW Plastics. The inner layer of the bottle of Ex.3 contained 85.0 wt % KW-101 and 15.0 wt % colorant, whereas the inner layer of the bottle of Ex. 4 contained 100.0 wt % KW-102. In contrast to the bottles of Ex.3-4, the inner and outer layers of the bottle of Ex.5 both contained 85.0 wt % HYA-600 virgin polymer and 15.0 wt % colorant.

For comparison purposes, two more polymeric bottles (Comparative Examples 2 and 3) having the same dimensions as the bottles of Ex.3-4 but only one layer were blow molded. The bottle of C.Ex.2 contained 97 wt % HYA-600, which is a virgin HDPE polymer commercially available from ExxonMobil, and 3 wt % colorant. In contrast, the bottle of C.Ex.3 contained a mc-PCR, i.e., 28.5 wt % KW-102. The bottle of C.Ex.3 also contained 68.5 wt % HYA-600 and 3 wt % colorant. The compositions and relative thicknesses of the different layers of the bottles of Ex.3-4 and C.Ex.2-3 are reported in Table 2 below. All colorants used in the bottles of C.Ex.2-3 and Ex.3-5 contained silver pearlescent pigment mixed with an LLDPE polymer.

The average resistance to top load, Drop Impact Resistance (DIR), and ESCR were measured for the bottles of Ex.3-5 and C.Ex.2-3. The results of these measurements are shown in Table 2 below, and a description of these measurements are provided later. Surprisingly, it was found that the multi-layered bottle of Ex.4, which contained mc-PCR in its inner layer and nc-PCR in its outer layer exhibited better Drop Impact Resistance and ESCR than the multi-layered bottles of Ex.3 and Ex.5 and the single-layered bottles of C.Ex.2-3. As such, the bottle of Ex.4 is less likely to experience cracking due to stress compared to the other bottles. While the gloss and color values of this bottle (Ex.4), were lower than the gloss and color values of the other bottles (Ex.3, Ex.5, and C.Ex.2-3), they were still suitable. Also, the multi-layered bottle of Ex.3, which contained nc-PCR in both its inner and outer layers, unexpectedly exhibited an average resistance to top load and a color value comparable to that of the single-layered bottles of C.Ex.2-3. However, this bottle (Ex.3) also had lower Drop Impact Resistance and ESCR than the bottle containing mc-PCR in its inner layer (Ex.4). The multi-layered bottle of Ex.5, which contained HDPE virgin polymer in both its inner and outer layers, also exhibited a higher color value than all other bottles, a gloss value comparable to that of the single-layered bottles of C.Ex.2-3, and higher Drop Impact Resistance and ESCR values than the multi-layered bottle of Ex.3, which contained nc-PCR in both its outer and inner layers.

TABLE 2
Compositions and Properties of Ex. 3-5 and C. Ex. 2-3

| | Layer | | | | | | | | |
|---|---|---|---|---|---|---|---|---|---|
| | Distri., | | | | Ave. | | | | |
| | Inner/ | | | | Top | | | | |
| | Middle/ | Inner | Middle | Outer | Load | | | | |
| | Outer | Layer | Layer | Layer | Resist. | DIR | ESCR | Color | Gloss |
| | (wt %) | (wt %) | (wt %) | (wt %) | (lbs) | (ft) | F50 | (L) | at 60° |
| C. Ex. 2 | Mono- | | 97.0% | | 25.3 | 8 | 947 | 53.7 | 15.6 |
| | layer | | HYA- | | | | | | |
| | | | 600/ | | | | | | |
| | | | 3.0% | | | | | | |
| | | | colorant | | | | | | |
| C. Ex. 3 | Mono- | | 68.5% | | 25.6 | 6 | 727 | 48.1 | 12.4 |
| | layer | | HYA- | | | | | | |
| | | | 600/ | | | | | | |
| | | | 28.5% | | | | | | |
| | | | KW- | | | | | | |
| | | | 102/ | | | | | | |
| | | | 3.0% | | | | | | |
| | | | colorant | | | | | | |
| Ex. 3 | 10/80/ | 85.0% | 100.0% | 85.0% | 24.1 | 4 | 296 | 53.7 | 11.5 |
| | 10 | KW- | KW-102 | KW- | | | | | |
| | | 101/ | | 101/ | | | | | |
| | | 15.0% | | 15.0% | | | | | |
| | | colorant | | colorant | | | | | |
| Ex. 4 | 10/80/ | 100.0% | 100.0% | 85.0% | 22.9 | 10 | 1001 | 41.0 | 11.3 |
| | 10 | KW- | KW-102 | KW-101/ | | | | | |
| | | 102 | | 15.0% | | | | | |
| | | | | colorant | | | | | |
| Ex. 5 | 10/80/ | 85.0% | 100.0% | 85.0% | | | | | |
| | 10 | HYA- | KW-102 | HYA- | 21.9 | 6 | 751 | 53.9 | 12.5 |
| | | 600/ | | 600/ | | | | | |
| | | 15.0% | | 15.0% | | | | | |
| | | colorant | | colorant | | | | | |

Also, four 32-ounce polymeric bottles having the same weight (40 g) (Examples 6, 7, 8 and 9) were blow molded that were similar to the bottle of Ex. 4 except that they included 10.0 wt % modifier in the outer layer in addition to 75.0 wt % KW-101 (mc-PCR) and 15.0 wt % colorant. Both the middle layer and the inner layer of the bottles of Ex.6-9 contained 100.0 wt % KW-102 (mc-PCR). All colorants used in the bottles of Ex.6-9 contained silver pearlescent pigment mixed with an LLDPE polymer. The modifier used in Ex. 6 was VISTAMAXX® 3020 (polypropylene-based elastomer); the modifier used in Ex. 7 was EXCEED® 6026 (LLDPE copolymer); the modifier used in Ex. 8 was ENABLE® 2703 (LLDPE copolymer); and the modifier used in Ex. 9 was ENGAGE® 8150 (polyethylene-based elastomer). The compositions of the bottles of Ex.6-9 are depicted in Table 3 below.

The average resistance to top load, Drop Impact Resistance, and ESCR were measured for the bottles of Ex.6-9. The results of these measurements are shown in Table 3 below, and a description of these measurements are provided later. The bottles of Ex.7-9, which included EXCEED® 6026, ENABLE® 2703, and ENGAGE® 8150, respectively, exhibited improved Drop Impact Resistance relative to the bottle of Ex. 4. Also, the bottle of Ex. 7 exhibited an ESCR comparable to that of the bottle of Ex. 4. The bottle of Ex. 7, which included EXCEED® 6026 as the modifier, unexpectedly exhibited better average resistance to top load, Drop Impact Resistance, and ESCR than the bottles (Ex.6,8-9) containing other types of modifier.

TABLE 3
Compositions and Properties of Ex. 6-9

| | Layer | | | | | | |
|---|---|---|---|---|---|---|---|
| | Distribution, | | | | | | |
| | Inner/ | Average | Drop | | | | |
| | Middle/ | Inner | Middle | | Top Load | Impact | |
| | Outer | Layer | Layer | Outer Layer | Resistance | Resistance | ESCR |
| | (wt %) | (wt %) | (wt %) | (wt %) | (lbs) | (ft) | F50 |
| Ex. 6 | 10/80/10 | 100.0% | 100.0% | 75.0% KW-101/ | 21.0 | 8 | 954 |
| | | KW-102 | KW- | 15.0% colorant/ | | | |
| | | | 102 | 10.0% | | | |
| | | | | VISTAMAXX ® | | | |
| | | | | 3020 | | | |
| Ex. 7 | 10/80/10 | 100.0% | 100.0% | 75.0% KW-101/ | 21.3 | 12 | 990 |
| | | KW-102 | KW- | 15.0% colorant/ | | | |
| | | | 102 | 10.0% | | | |
| | | | | EXCEED ® 6026 | | | |
| Ex. 8 | 10/80/10 | 100.0% | 100.0% | 75.0% KW-101/ | 20.4 | 11 | 409 |
| | | KW-102 | KW- | 15.0% colorant/ | | | |
| | | | 102 | 10.0% | | | |
| | | | | ENABLE ® | | | |
| | | | | 2703 | | | |
| Ex. 9 | 10/80/10 | 100.0% | 100.0% | 75.0% KW-101/ | 20.4 | 11 | 827 |
| | | KW-102 | KW- | 15.0% colorant/ | | | |
| | | | 102 | 10.0% | | | |
| | | | | ENGAGE ® | | | |
| | | | | 8150 | | | |

### Testing Methods

Resistance to top load was measured according to ASTM D-2659 using a moving platen device with a load cell. The containers were filled with room temperature tap water and capped. The speed of the moving platen was set at 1.8 inches per minute. The load values were measured at both one-quarter inch deflection and at yield.

Drop Impact Resistance was measured according to the drop test procedure set forth in cumulative method C of ASTM D-2463. Containers were filled with water, capped, and dropped, initially from ten feet. Each subsequent drop was increased one foot in height until failure. The average cumulative drop height was then calculated as shown in ASTM D-2463.

Environmental stress crack resistance (ESCR) was measured according to ASTM D-2561. The test was performed at a temperature of 140° F. and a constant internal pressure of 4.7 psi. The containers were one-third filled with a ten percent solution of Igepal® in water. Igepal® is a nonyl-phenoxy poly (ethyleneoxy) ethanol commercially available from GAF Corp. F50 was calculated per the test method above.

Color was measured in accordance with ASTM D6290 using the L-scale, which measures lightness versus darkness. Gloss at a 600 angle was measured in accordance with ASTM D523-14.

### LISTING OF EMBODIMENTS

This disclosure can further include any one or more of the following non-limiting embodiments:

1. A packaging material, comprising: an outer layer comprising a first colorant and from about 70 wt % to about 99 wt % of a first post consumer resin (PCR); and an inner layer that is about 3 wt % to about 99 wt % of the total packaging material, the inner layer comprising a polymer.

2. The packaging material according to embodiment 1, wherein the outer layer comprises from about 1 wt % to about 30 wt % of the first colorant, and wherein the first PCR comprises a mixed-color PCR or a natural-color PCR

3. The packaging material according to embodiment 1 or 2, wherein the polymer is a virgin polymer and the inner layer comprises from about 70 wt % to about 100 wt % of the virgin polymer.

4. The packaging material according to any embodiment 1 to 3, wherein the polymer is a second PCR and the inner layer comprises from about 70 wt % to about 100 wt % of the second PCR, and wherein the first PCR and the second PCR are the same or are different.

5. The packaging material according to embodiment 4, wherein the second PCR comprises a mixed-color PCR.

6. The packaging material according to any embodiment 1 to 5, wherein the polymer is a second PCR, wherein the inner layer comprises from about 70 wt % to about 95 wt % of the second PCR and a balance weight percent of a second colorant, wherein the first PCR and the second PCR are the same or are different, and wherein the first and second colorants are the same or are different.

7. The packaging material according to embodiment 6, wherein the second PCR comprises a natural-color PCR.

8. The packaging material according to any embodiment 1 to 7, further comprising a middle layer between the outer layer and the inner layer, the middle layer comprising from about 70 wt % to about 100 wt % of a third PCR and a balance weight percent of another colorant, wherein the inner layer is about 3 wt % to about 40 wt % of the total packaging material and the outer layer is about 3 wt % to about 40 wt % of the total packaging material, wherein the first PCR and the third PCR are the same or are different, and wherein the first colorant and the another colorant are the same or are different.

9. The packaging material according to embodiment 8, wherein the third PCR is a mixed-color PCR.

10. The packaging material according to any embodiment 1 to 9, further comprising a middle layer between the outer layer and the inner layer, the middle layer comprising waste material and from about 40 wt % to about 60 wt % of a third PCR, wherein the inner layer is about 3 wt % to about 40 wt % of the total packaging material and the outer layer is about 3 wt % to about 40 wt % of the total packaging material, and wherein the first PCR and the third PCR are the same or are different.

11. The packaging material according to any embodiment 1 to 10, wherein the inner layer comprises greater than about 0 wt % and less than or equal to about 15 wt % of a modifier, wherein the outer layer comprises greater than about 0 wt % and less than or equal to about 15 wt %, or wherein the inner layer and the outer layer comprise greater than about 0 wt % and less than or equal to about 15 wt %.

12. The packaging material according to any embodiment 1 to 11, wherein the first PCR comprises high-density polyethylene, polypropylene, polyethylene terephthalate, or combinations thereof.

13. A process for making a packaging material, comprising: coextruding an outer layer and an inner layer that is about 3 wt % to about 99 wt % of the total packaging material, the outer layer comprising a colorant and from about 70 wt % to about 99 wt % of a first post consumer resin (PCR), and the inner layer comprising a polymer.

14. The process for making the packaging material according to embodiment 13, further comprising coextruding a middle layer between the outer layer and the inner layer, the middle layer primarily comprising a second PCR, wherein the first and second PCR are the same or are different.

15. A packaging material, comprising: an outer layer comprising a first colorant and from about 70 wt % to about 99 wt % of a first virgin polymer; a middle layer that is about 40 wt % to about 95 wt % of the total packaging material, the middle layer comprising a PCR; and an inner layer comprising a second virgin polymer, wherein the first virgin polymer and the second virgin polymer are the same or are different.

16. The packaging material according to embodiment 15, wherein the outer layer comprises from about 1 wt % to about 30 wt % of the first colorant.

17. The packaging material according to embodiment 15 or 16, wherein the inner layer comprises from about 70 wt % to about 99 wt % of the second virgin polymer and from about 1 wt % to about 30 wt % of a second colorant, wherein the first colorant and the second colorant are the same or are different.

18. The packaging material according to any embodiment 15 to 17, wherein the first virgin polymer and the second virgin polymer comprise high-density polyethylene.

19. The packaging material according to any embodiment 15 to 18, wherein the middle layer directly contacts the outer layer, and wherein the middle layer comprises from about 70 wt % to about 100 wt % of the PCR.

20. The packaging material according to any embodiment 15 to 19, wherein the PCR comprises a mixed-color PCR.

21. The packaging material according to any embodiment 15 to 20, wherein the middle layer comprises waste material and from about 40 wt % to about 60 wt % of the PCR, wherein the inner layer is about 3 wt % to about 40 wt % of the total packaging material, and wherein the outer layer is about 3 wt % to about 40 wt % of the total packaging material.

22. The packaging material according to any embodiment 15 to 21, wherein the inner layer comprises greater than about 0 wt % and less than or equal to about 15 wt % of a modifier, wherein the outer layer comprises greater than about 0 wt % and less than or equal to about 15 wt % of a modifier, or wherein the inner layer and the outer layer comprise greater than about 0 wt % and less than or equal to about 15 wt % of a modifier.

23. A process for making a packaging material, comprising: coextruding an outer layer, a middle layer, and an inner layer, wherein the outer layer comprises a colorant and from about 70 wt % to about 99 wt % of a first virgin polymer, the middle layer comprises a PCR and is about 40 wt % to about 95 wt % of the total packaging material, and the inner layer comprises a second virgin polymer, wherein the first virgin polymer and the second virgin polymer are the same or are different.

24. A packaging material, comprising: an outer layer comprising a colorant; a middle layer that is about 40 wt % to about 95 wt % of the total packaging material, the middle layer comprising a PCR; and an inner layer comprising a virgin polymer.

25. The packaging material according to embodiment 24, wherein the colorant comprises linear low-density polyethylene, high-density polyethylene, or combinations thereof.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

What is claimed is:

1. A packaging material, comprising:
an outer layer comprising a first colorant and from about 70 wt % to about 99 wt % of a first post consumer resin (PCR); and
an inner layer that is about 3 wt % to about 99 wt % of the total packaging material, the inner layer comprising a polymer.

2. The packaging material of claim 1, wherein the outer layer comprises from about 1 wt % to about 30 wt % of the first colorant, and wherein the first PCR comprises a mixed-color PCR or a natural-color PCR.

3. The packaging material of claim 1, wherein the polymer is a virgin polymer and the inner layer comprises from about 70 wt % to about 100 wt % of the virgin polymer.

4. The packaging material of claim 1, wherein the polymer is a second PCR and the inner layer comprises from about 70 wt % to about 100 wt % of the second PCR, and wherein the first PCR and the second PCR are the same or are different.

5. The packaging material of claim 4, wherein the second PCR comprises a mixed-color PCR.

6. The packaging material of claim 1, wherein the polymer is a second PCR, wherein the inner layer comprises from about 70 wt % to about 95 wt % of the second PCR and a balance weight percent of a second colorant, wherein the first PCR and the second PCR are the same or are different, and wherein the first and second colorants are the same or are different.

7. The packaging material of claim 6, wherein the second PCR comprises a natural-color PCR.

8. The packaging material of claim 1, further comprising a middle layer between the outer layer and the inner layer, the middle layer comprising from about 70 wt % to about 100 wt % of a third PCR and a balance weight percent of another colorant, wherein the inner layer is about 3 wt % to about 40 wt % of the total packaging material and the outer layer is about 3 wt % to about 40 wt % of the total packaging material, wherein the first PCR and the third PCR are the same or are different, and wherein the first colorant and the another colorant are the same or are different.

9. The packaging material of claim 8, wherein the third PCR is a mixed-color PCR.

10. The packaging material of claim 1, further comprising a middle layer between the outer layer and the inner layer, the middle layer comprising waste material and from about 40 wt % to about 60 wt % of a third PCR, wherein the inner layer is about 3 wt % to about 40 wt % of the total packaging material and the outer layer is about 3 wt % to about 40 wt % of the total packaging material, and wherein the first PCR and the third PCR are the same or are different.

11. The packaging material of claim 1, wherein the inner layer comprises greater than about 0 wt % and less than or equal to about 15 wt % of a modifier, wherein the outer layer comprises greater than about 0 wt % and less than or equal to about 15 wt % of a modifier, or wherein the inner layer and the outer layer comprise greater than about 0 wt % and less than or equal to about 15 wt % of a modifier.

12. The packaging material of claim 1, wherein the first PCR comprises high-density polyethylene, polypropylene, polyethylene terephthalate, or combinations thereof.

13. A process for making a packaging material, comprising:
coextruding an outer layer and an inner layer that is about 3 wt % to about 99 wt % of the total packaging material, the outer layer comprising a colorant and from about 70 wt % to about 99 wt % of a first post consumer resin (PCR), and the inner layer comprising a polymer.

14. The process for making the packaging material of claim 13, further comprising
coextruding a middle layer between the outer layer and the inner layer, the middle layer primarily comprising a second PCR, wherein the first and second PCR are the same or are different.

15. A packaging material, comprising:
an outer layer comprising a first colorant and from about 70 wt % to about 99 wt % of a first virgin polymer;
a middle layer that is about 40 wt % to about 95 wt % of the total packaging material, the middle layer comprising a PCR; and
an inner layer comprising a second virgin polymer, wherein the first virgin polymer and the second virgin polymer are the same or are different.

16. The packaging material of claim 15, wherein the outer layer comprises from about 1 wt % to about 30 wt % of the first colorant.

17. The packaging material of claim 15, wherein the inner layer comprises from about 70 wt % to about 99 wt % of the second virgin polymer and from about 1 wt % to about 30 wt % of a second colorant, wherein the first colorant and the second colorant are the same or are different.

18. The packaging material of claim 15, wherein the first virgin polymer and the second virgin polymer comprise high-density polyethylene.

19. The packaging material of claim 15, wherein the middle layer directly contacts the outer layer, and wherein the middle layer comprises from about 70 wt % to about 100 wt % of the PCR.

20. The packaging material of claim 15, wherein the PCR comprises a mixed-color PCR.

21. The packaging material of claim 15, wherein the middle layer comprises waste material and from about 40 wt % to about 60 wt % of the PCR, wherein the inner layer is about 3 wt % to about 40 wt % of the total packaging material, and wherein the outer layer is about 3 wt % to about 40 wt % of the total packaging material.

22. The packaging material of claim 15, wherein the inner layer comprises greater than about 0 wt % and less than or equal to about 15 wt % of a modifier, wherein the outer layer comprises greater than about 0 wt % and less than or equal to about 15 wt % of a modifier, or wherein the inner layer and the outer layer comprise greater than about 0 wt % and less than or equal to about 15 wt % of a modifier.

23. A process for making a packaging material, comprising:
coextruding an outer layer, a middle layer, and an inner layer, wherein the outer layer comprises a colorant and from about 70 wt % to about 99 wt % of a first virgin polymer, the middle layer comprises a PCR and is about 40 wt % to about 95 wt % of the total packaging material, and the inner layer comprises a second virgin polymer, wherein the first virgin polymer and the second virgin polymer are the same or are different.

24. A packaging material, comprising:
an outer layer comprising a colorant;
a middle layer that is about 40 wt % to about 95 wt % of the total packaging material, the middle layer comprising a PCR; and
an inner layer comprising a virgin polymer.

25. The packaging material of claim 24, wherein the colorant comprises linear low-density polyethylene, high-density polyethylene, or combinations thereof.
